(19) United States
(12) Patent Application Publication
(10) Pub. No.: US 2017/0188281 A1
(43) Pub. Date: Jun. 29, 2017

(54) METHOD AND APPARATUS FOR CONTROLLING ACTIVE SET UPDATING

(71) Applicant: HUAWEI TECHNOLOGIES CO., LTD., Shenzhen, Guangdong (CN)

(72) Inventors: Zhe LI, Wuhan (CN); Shouxing PENG, Shenzhen (CN)

(73) Assignee: HUAWEI TECHNOLOGIES CO., LTD., Shenzhen, Guangdong (CN)

(21) Appl. No.: 15/327,507

(22) PCT Filed: Jul. 24, 2014
(86) PCT No.: PCT/CN2014/082922

§ 371 Date: Jan. 19, 2017

(51) Int. Cl. H04W 36/18; H04W 36/00; H04W 36/30; H04L 12/26; H04W 24/10

(52) U.S. Cl. CPC H04W 36/18; H04L 43/16; H04W 24/10; H04W 36/30; H04W 36/0083

(57) ABSTRACT

A method and an apparatus for controlling active set updating. In the method, a mobile terminal acquires a preconfigured threshold adjustment value, a modified threshold obtained when an initial threshold initially configured by a network side is modified based on the threshold adjustment value is acquired by the mobile terminal. The modified threshold is less than the initial threshold, and an active set is updated according to the modified threshold. The modified threshold is equal to an initial threshold minus the threshold adjustment value.

### CROSS REFERENCE TO RELATED APPLICATIONS

This application is a national stage of International Application No. PCT/CN2014/082922, filed on Jul. 24, 2014, which is hereby incorporated by reference in its entirety.

### TECHNICAL FIELD

The present invention relates to the field of communications technologies, and in particular, to a method and an apparatus for controlling active set updating.

### BACKGROUND

In a mobile communications system, when a mobile terminal moves out of an original serving cell and enters another serving cell, handover needs to be performed to ensure communication continuity.

Handover is mainly classified into hard handover and soft handover. Hard handover refers to that a mobile terminal first breaks an original link and establishes a new link. Soft handover refers to that a mobile terminal breaks an original link on the basis that a new link has been established. As a soft handover technology is implemented, while being in service, a mobile terminal in service can simultaneously communicate with at least two cells, and a specific cell with which the mobile terminal communicates is determined by a soft handover process. A process of implementing soft handover may be considered as a process of determining a cell that is currently used by a mobile terminal, and the process of determining a cell that is currently used by a mobile terminal may also be referred to as a process of determining an active set (a pilot signal that is allocated to the mobile terminal and that is associated with a forward traffic channel). Generally, a cell added to an active set is a cell that is currently used by a mobile terminal.

To ensure communication quality of a mobile terminal, an active set generally needs to be updated. Currently, after a mobile terminal enters a service state, the mobile terminal measures signal strength of neighboring cells, and updates an active set according to signal strength that is obtained by means of measurement and a fixed threshold that is delivered by a network side. If there is a cell that has signal strength, within a set time, staying higher than the fixed threshold delivered by the network side but that is not in the active set, the cell that has signal strength higher than the fixed threshold delivered by the network side but that is not in the active set is added to a candidate set (a pilot signal that is currently not in the active set, but has been received by the mobile terminal and that has sufficient signal strength indicating that a forward traffic channel associated with the pilot signal can be successfully demodulated), a measurement report is generated and sent to the network side. The network side instructs, according to the received measurement report, the mobile terminal to add, to the active set, the cell that has signal strength higher than the fixed threshold delivered by the network side but that is not in the active set. If a cell that has signal strength, within a set time, staying lower than the fixed threshold delivered by the network side exists in the active set, the mobile terminal generates a measurement report and sends the measurement report to the network side, and the network side instructs, according to the received measurement report, the mobile terminal to delete, from the active set, the cell that has signal strength, within the set time, staying lower than the fixed threshold delivered by the network side.

In the foregoing process of updating the active set, the mobile terminal compares the fixed threshold delivered by the network side with signal strength obtained by means of measurement. In a scenario of a relatively desirable network environment, communication quality of the mobile terminal can be greatly improved. However, in a scenario of relatively poor radio frequency performance of the mobile terminal or a relatively poor network environment (an engineering quality problem, undesirable cell coverage, excessive user load, and the like on a network side), if the fixed threshold delivered by the network side keeps being used as a reference to update the active set, the network side cannot normally parse signaling sent by the mobile terminal, and problems such as frequent call drop or intermittent communication are caused and communication quality is relatively poor.

### SUMMARY

Embodiments of the present invention provide a method and an apparatus for controlling active set updating, to improve communication quality.

According to a first aspect, a method for controlling active set updating is provided, including:

acquiring a preconfigured threshold adjustment value;

acquiring a modified threshold obtained when an initial threshold initially configured by a network side is modified based on the threshold adjustment value, where the modified threshold is less than the initial threshold; and

updating an active set according to the modified threshold.

With reference to the first aspect, in a first implementation manner, the acquiring a modified threshold obtained when an initial threshold initially configured by a network side is modified based on the threshold adjustment value includes:

acquiring the initial threshold that is initially configured and delivered by the network side; and

decreasing the initial threshold by the threshold adjustment value to obtain the modified threshold.

With reference to the first implementation manner of the first aspect, in a second implementation manner, before the decreasing the initial threshold by the threshold adjustment value, the method further includes:

determining whether transmit power of a mobile terminal has reached the maximum; and

determining that the transmit power of the mobile terminal has reached the maximum.

With reference to the first aspect, in a third implementation manner, the acquiring a modified threshold obtained when an initial threshold initially configured by a network side is modified based on the threshold adjustment value includes:

reporting, to the network side, a modification instruction for modifying the initial threshold initially configured by the network side, and sending the threshold adjustment value to the network side; and

acquiring the modified threshold delivered by the network side, where the modified threshold is obtained when the network side decreases the initial threshold by the threshold adjustment value according to the modification instruction and the threshold adjustment value.

With reference to the third implementation manner of the first aspect, in a fourth implementation manner, before the reporting, to the network side, a modification instruction for modifying the initial threshold initially configured by the network side, the method further includes:

determining whether transmit power of a mobile terminal has reached the maximum; and

determining that the transmit power of the mobile terminal has reached the maximum.

With reference to the second implementation manner of the first aspect or the fourth implementation manner of the first aspect, in a fifth implementation manner, after the determining that the transmit power of the mobile terminal has reached the maximum, the method further includes:

determining whether a quantity of cells in the active set has reached saturation; and

determining that the quantity of the cells in the active set has not reached saturation.

With reference to the second implementation manner of the first aspect or the fourth implementation manner of the first aspect, in a sixth implementation manner, after the determining that the transmit power of the mobile terminal has reached the maximum, the method further includes:

determining whether a cell that has signal strength staying greater than a set value within a set time exists in the active set; and

if a cell that has signal strength staying greater than the set value within the set time exists, marking the cell that is in the active set and that has signal strength staying greater than the set value within the set time, to obtain a marked cell; or

if a cell that has signal strength staying greater than the set value within the set time does not exist, determining whether a current threshold has been modified, and determining that the current threshold has not been modified.

With reference to the sixth implementation manner of the first aspect, in a seventh implementation manner, after the marking the cell that is in the active set and that has signal strength staying greater than the set value within the set time, to obtain a marked cell, the method further includes:

determining whether a quantity of cells in the active set has reached saturation; and

if the quantity of the cells in the active set has reached saturation, selecting at least one cell from marked cells, and reporting, to the network side, a measurement report that records signal strength of the at least one cell, where the signal strength of the at least one cell that is recorded in the measurement report is less than actual signal strength of the at least one cell; or

if the quantity of the cells in the active set has not reached saturation, determining whether a current threshold has been modified, and determining that the current threshold has not been modified.

With reference to the seventh implementation manner of the first aspect, in an eighth implementation manner, before the reporting, to the network side, a measurement report, the method further includes:

determining whether a quantity of cells in a candidate set has reached saturation, and determining that the quantity of the cells in the candidate set has not reached saturation; or

determining whether a current threshold has been modified, and determining that the current threshold has been modified.

With reference to the seventh implementation manner of the first aspect, in a ninth implementation manner, the selecting at least one cell from marked cells includes:

selecting, in a chronological order of marking moments of the marked cells, at least one cell from the marked cells; or

selecting, in descending order of signal strength of the marked cells, at least one cell from the marked cells.

According to a second aspect, a method for controlling active set updating is provided, including:

acquiring a modification instruction and a threshold adjustment value that are reported by a mobile terminal;

decreasing, by the threshold adjustment value according to the modification instruction and the threshold adjustment value, an initial threshold that is initially configured and that is used to update an active set, to obtain a modified threshold, where the modified threshold is less than the initial threshold; and

delivering the modified threshold.

According to a third aspect, an apparatus for controlling active set updating is provided, including an acquiring unit and an updating unit, where

the acquiring unit is configured to acquire a preconfigured threshold adjustment value, and acquire a modified threshold obtained when an initial threshold initially configured by a network side is modified based on the threshold adjustment value, where the modified threshold is less than the initial threshold; and

the updating unit is configured to update an active set according to the modified threshold acquired by the acquiring unit.

With reference to the third aspect, in a first implementation manner, the acquiring unit is configured to acquire the initial threshold that is initially configured and delivered by the network side;

the apparatus further includes a modification unit, where

the modification unit is configured to decrease the initial threshold acquired by the acquiring unit by the threshold adjustment value to obtain the modified threshold; and

the acquiring unit is specifically configured to acquire, in the following manner, the modified threshold obtained when the initial threshold initially configured by the network side is modified based on the threshold adjustment value:

acquiring the modified threshold obtained when the modification unit decreases the initial threshold by the threshold adjustment value.

With reference to the first implementation manner of the third aspect, in a second implementation manner, the apparatus further includes a determining unit, and the determining unit is configured to:

before the modification unit decreases the initial threshold by the threshold adjustment value, determine whether transmit power of a mobile terminal has reached the maximum, and determine that the transmit power of the mobile terminal has reached the maximum.

With reference to the third aspect, in a third implementation manner, the apparatus further includes a reporting unit, and the reporting unit is configured to:

report, to the network side, a modification instruction for modifying the initial threshold initially configured by the network side, and send the threshold adjustment value to the network side; and

the acquiring unit is specifically configured to acquire, in the following manner, the modified threshold obtained when the initial threshold initially configured by the network side is modified based on the threshold adjustment value:

acquiring the modified threshold delivered by the network side, where the modified threshold is obtained when the network side decreases the initial threshold by the threshold adjustment value according to the modification instruction and the threshold adjustment value.

With reference to the third implementation manner of the third aspect, in a fourth implementation manner, the determining unit is further configured to:

before the reporting unit reports, to the network side, the modification instruction for modifying the initial threshold initially configured by the network side, determine whether transmit power of a mobile terminal has reached the maximum, and determine that the transmit power of the mobile terminal has reached the maximum.

With reference to the second implementation manner of the third aspect or the fourth implementation manner of the third aspect, in a fifth implementation manner, the determining unit is further configured to:

after determining that the transmit power of the mobile terminal has reached the maximum, determine whether a quantity of cells in the active set has reached saturation, and determine that the quantity of the cells in the active set has not reached saturation.

With reference to the second implementation manner of the third aspect or the fourth implementation manner of the third aspect, in a sixth implementation manner, the determining unit is further configured to:

after determining that the transmit power of the mobile terminal has reached the maximum, determine whether a cell that has signal strength staying greater than a set value within a set time exists in the active set; and

the apparatus further includes a marking unit, where

the marking unit is configured to: when a determining result of the determining unit is that a cell that has signal strength staying greater than the set value within the set time exists in the active set, mark the cell that is in the active set and that has signal strength staying greater than the set value within the set time, to obtain a marked cell; and

the determining unit is further configured to: when a determining result is that a cell that has signal strength staying greater than the set value within the set time does not exist in the active set, determine whether a current threshold has been modified, and determine that the current threshold has not been modified.

With reference to the sixth implementation manner of the third aspect, in a seventh implementation manner, the determining unit is further configured to:

after the marking unit marks the cell that is in the active set and that has signal strength staying greater than the set value within the set time, to obtain a marked cell, determine whether a quantity of cells in the active set has reached saturation; and

the reporting unit is configured to: when a determining result of the determining unit is that the quantity of the cells in the active set has reached saturation, select at least one cell from marked cells, and report, to the network side, a measurement report that records signal strength of the at least one cell, where the signal strength of the at least one cell that is recorded in the measurement report is less than actual signal strength of the at least one cell; or

the determining unit is further configured to: when a determining result is that the quantity of the cells in the active set has not reached saturation, determine whether a current threshold has been modified, and determine that the current threshold has not been modified.

With reference to the seventh implementation manner of the third aspect, in an eighth implementation manner, the determining unit is further configured to:

before the reporting unit reports the measurement report to the network side, determine whether a quantity of cells in a candidate set has reached saturation, and determine that the quantity of the cells in the candidate set has not reached saturation; or

before the reporting unit reports the measurement report to the network side, determine whether a current threshold has been modified, and determine that the current threshold has been modified.

With reference to the seventh implementation manner of the third aspect, in a ninth implementation manner, the reporting unit is specifically configured to select at least one cell from the marked cells in the following manner:

selecting, in a chronological order of marking moments of the marked cells, at least one cell from the marked cells; or

selecting, in descending order of signal strength of the marked cells, at least one cell from the marked cells.

According to a fourth aspect, an apparatus for controlling active set updating is provided, including an acquiring unit, a modification unit, and a delivering unit, where

the acquiring unit is configured to acquire a modification instruction and a threshold adjustment value that are reported by a mobile terminal;

the modification unit is configured to decrease, by the threshold adjustment value according to the modification instruction and the threshold adjustment value that are acquired by the acquiring unit, an initial threshold that is initially configured and that is used to update an active set, to obtain a modified threshold, where the modified threshold is less than the initial threshold; and

the delivering unit is configured to deliver the modified threshold obtained by the modification unit.

According to a fifth aspect, an apparatus for controlling active set updating is provided, including a communications interface, a processor, a memory, and a bus, where the communications interface, the processor, and the memory are all connected to the bus, where

the memory is configured to store program code executed by the processor; and

the processor is configured to invoke a program stored by the memory, to perform the following functions:

by using the communications interface, acquiring a preconfigured threshold adjustment value, and acquiring a modified threshold obtained when an initial threshold initially configured by a network side is modified based on the threshold adjustment value; and updating an active set according to the modified threshold, where the modified threshold is less than the initial threshold.

With reference to the fifth aspect, in a first implementation manner, the processor is specifically configured to acquire, in the following manner, the modified threshold obtained when the initial threshold initially configured by the network side is modified based on the threshold adjustment value:

acquiring, by using the communications interface, the initial threshold delivered by the network side; and

decreasing the initial threshold by the threshold adjustment value to obtain the modified threshold.

With reference to the first implementation manner of the fifth aspect, in a second implementation manner, the processor is further configured to:

before decreasing the initial threshold by the threshold adjustment value, determine whether transmit power of a mobile terminal has reached the maximum, and determine that the transmit power of the mobile terminal has reached the maximum.

With reference to the fifth aspect, in a third implementation manner, the processor is specifically configured to acquire, in the following manner, the modified threshold obtained when the initial threshold initially configured by the network side is modified based on the threshold adjustment value:

reporting, to the network side by using the communications interface, a modification instruction for modifying the initial threshold initially configured by the network side, and sending the threshold adjustment value to the network side; and acquiring, by using the communications interface, the modified threshold delivered by the network side, where the modified threshold is obtained when the network side decreases the initial threshold by the threshold adjustment value according to the modification instruction and the threshold adjustment value.

With reference to the third implementation manner of the fifth aspect, in a fourth implementation manner, the processor is further configured to:

before reporting, to the network side by using the communications interface, the modification instruction for modifying the initial threshold initially configured by the network side, determine whether transmit power of a mobile terminal has reached the maximum, and determine that the transmit power of the mobile terminal has reached the maximum.

With reference to the second implementation manner of the fifth aspect or the fourth implementation manner of the fifth aspect, in a fifth implementation manner, the processor is further configured to:

after determining that the transmit power of the mobile terminal has reached the maximum, determine whether a quantity of cells in the active set has reached saturation, and determine that the quantity of the cells in the active set has not reached saturation.

With reference to the second implementation manner of the fifth aspect or the fourth implementation manner of the fifth aspect, in a sixth implementation manner, the processor is further configured to:

after determining that the transmit power of the mobile terminal has reached the maximum, determine whether a cell that has signal strength staying greater than a set value within a set time exists in the active set; and

if a cell that has signal strength staying greater than the set value within the set time exists, mark the cell that is in the active set and that has signal strength staying greater than the set value within the set time, to obtain a marked cell; or

if a cell that has signal strength staying greater than the set value within the set time does not exist, determine whether a current threshold has been modified, and determine that the current threshold has not been modified.

With reference to the sixth implementation manner of the fifth aspect, in a seventh implementation manner, the processor is further configured to:

after marking the cell that is in the active set and that has signal strength staying greater than the set value within the set time, to obtain a marked cell, determine whether a quantity of cells in the active set has reached saturation; and

if the quantity of the cells in the active set has reached saturation, select at least one cell from marked cells, and report, to the network side, a measurement report that records signal strength of the at least one cell, where the signal strength of the at least one cell that is recorded in the measurement report is less than actual signal strength of the at least one cell; or

if the quantity of the cells in the active set has not reached saturation, determine whether a current threshold has been modified, and determine that the current threshold has not been modified.

With reference to the seventh implementation manner of the fifth aspect, in an eighth implementation manner, the processor is further configured to:

before reporting the measurement report to the network side, determine whether a quantity of cells in a candidate set has reached saturation, and determine that the quantity of the cells in the candidate set has not reached saturation; or

before reporting the measurement report to the network side, determine whether a current threshold has been modified, and determine that the current threshold has been modified.

With reference to the seventh implementation manner of the fifth aspect, in a ninth implementation manner, the processor is specifically configured to select at least one cell from the marked cells in the following manner:

selecting, in a chronological order of marking moments of the marked cells, at least one cell from the marked cells; or

selecting, in descending order of signal strength of the marked cells, at least one cell from the marked cells.

According to a sixth aspect, an apparatus for controlling active set updating is provided, including a memory, a processor, a transmitter, and a bus, where the memory, the processor, and the transmitter are all connected to the bus, where

the memory is configured to store program code executed by the processor;

the processor is configured to invoke a program stored by the memory, to perform the following functions:

acquiring a modification instruction and a threshold adjustment value that are reported by a mobile terminal, decreasing, by the threshold adjustment value according to the modification instruction and the threshold adjustment value, an initial threshold that is initially configured and that is used to update an active set, to obtain a modified threshold, and controlling the transmitter to deliver the modified threshold, where the modified threshold is less than the initial threshold; and

the transmitter is configured to deliver the modified threshold.

In the method and apparatus for controlling active set updating provided in the embodiments of the present invention, an active set is no longer updated by using an initial threshold initially configured by a network side, and the active set is updated based on an acquired modified threshold obtained when the initial threshold is modified, where the modified threshold is less than the initial threshold, so that more cells can enter the active set. Therefore, the embodiments of the present invention can better adapt to actual radio frequency performance and an actual network status of a mobile terminal, and the mobile terminal can simultaneously use more cell signals, thereby improving communication quality.

### BRIEF DESCRIPTION OF DRAWINGS

FIG. 1 is a first implementation flowchart of a method for controlling active set updating in a soft handover process according to an embodiment of the present invention;

FIG. 2 is a second implementation flowchart of a method for controlling active set updating in a soft handover process according to an embodiment of the present invention;

FIG. 3 is a third implementation flowchart of a method for controlling active set updating in a soft handover process according to an embodiment of the present invention;

FIG. 4 is a first implementation flowchart of modifying an initial threshold according to an embodiment of the present invention;

FIG. 5 is a second implementation flowchart of modifying an initial threshold according to an embodiment of the present invention;

FIG. 6 is a third implementation flowchart of modifying an initial threshold according to an embodiment of the present invention;

FIG. 7 is a fourth implementation flowchart of a method for controlling active set updating in a soft handover process according to an embodiment of the present invention;

FIG. 8 is a fifth implementation flowchart of a method for controlling active set updating in a soft handover process according to an embodiment of the present invention;

FIG. 9A to FIG. 9E are first schematic composition diagrams of an apparatus for controlling active set updating in a soft handover process according to an embodiment of the present invention;

FIG. 10 is a second schematic composition diagram of an apparatus for controlling active set updating in a soft handover process according to an embodiment of the present invention;

FIG. 11 is a third schematic composition diagram of an apparatus for controlling active set updating in a soft handover process according to an embodiment of the present invention; and

FIG. 12 is a fourth schematic composition diagram of an apparatus for controlling active set updating in a soft handover process according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

In a communication process, if a mobile terminal further uses a signal transmitted by a peripheral network device (for example, a base station) in addition to a signal transmitted by a network device (for example, a base station) to which a current cell belongs, a call drop or intermittent communication problem caused by relatively poor radio frequency performance of the mobile terminal or a relatively poor network environment can be alleviated. In the embodiments of the present invention, based on the foregoing principle, a threshold for updating an active set in a soft handover process is controlled to change, so that more cells can enter the active set, and a quantity of cells in the active set is increased, thereby improving communication quality of the mobile terminal.

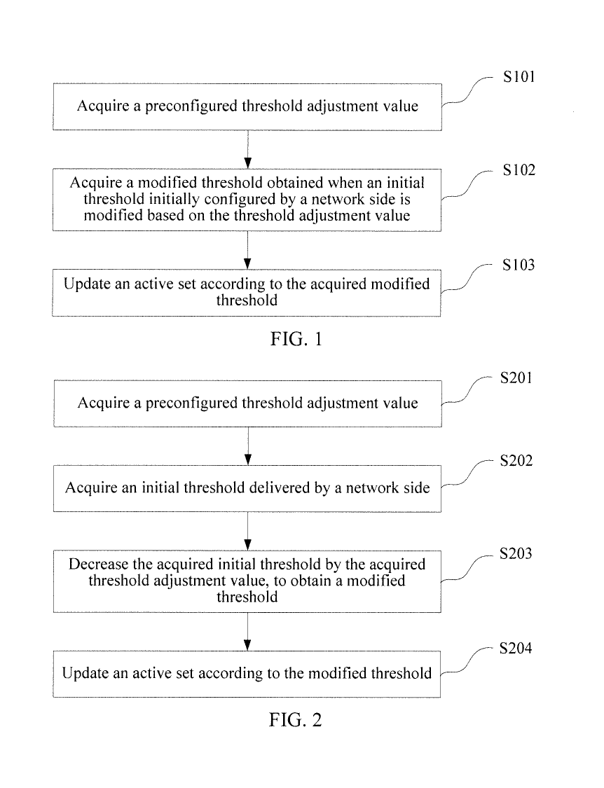

FIG. 1 shows a method for controlling active set updating in a soft handover process in an embodiment of the present invention. The method may be executed by a mobile terminal or any component in a mobile terminal, which is not limited herein in this embodiment of the present invention. As shown in FIG. 1, the method includes:

S101. Acquire a preconfigured threshold adjustment value.

Specifically, a network device (for example, a base station) on a network side generally initially configures an initial threshold used to update an active set, where a unit of the initial threshold may be the same as a unit of signal strength of a cell, and may be, for example, dB. In the prior art, a mobile terminal acquires the initial threshold, compares signal strength of a cell with the initial threshold, and further updates the active set. A difference of this embodiment of the present invention from the prior art lies in that in this embodiment of the present invention, a mobile terminal acquires a preconfigured threshold adjustment value, the threshold adjustment value is a fixed numerical value preconfigured, where a unit of the fixed value may be the same as a unit of signal strength of a cell, and may be, for example, dB, and the threshold adjustment value is used to adjust (decrease or increase) the initial threshold to obtain a modified threshold. In this embodiment of the present invention, the preconfigured threshold adjustment value may be a fixed value determined according to radio frequency performance of the mobile terminal and an empirical numerical value in a process of actual use.

S102. Acquire a modified threshold obtained when an initial threshold initially configured by a network side is modified based on the threshold adjustment value.

In this embodiment of the present invention, the modifying, based on the threshold adjustment value, the initial threshold initially configured by the network side may include decreasing the initial threshold by the corresponding threshold adjustment value, and certainly may also include increasing the initial threshold by the corresponding threshold adjustment value. In this embodiment of the present invention, to implement that more cells can enter the active set as compared with a conventional method of updating the active set, it is preferably set that the initial threshold is decreased by the corresponding threshold adjustment value, so that the modified threshold obtained after modification is less than the initial threshold initially configured by the network side.

S103. Update an active set according to the modified threshold acquired in S102.

Specifically, in this embodiment of the present invention, a process of updating the active set according to the acquired modified threshold preferably includes increasing a quantity of cells in the active set, and certainly, a cell that is in the active set and that does not play a very important role in current communication of the mobile terminal may also be deleted. For example, in this embodiment of the present invention, a cell that has signal strength staying greater than the modified threshold within a set time but that is not in the active set may be added to a candidate set, a measurement report may be generated and sent to the network side, and the network side instructs, according to the received measurement report, the mobile terminal to add, to the active set, the cell that has signal strength greater than the modified threshold but that is not in the active set. For another example, in this embodiment of the present invention, a cell that has signal strength staying less than the modified threshold within a set time may further be deleted from the active set according to an instruction delivered by the network side.

In the method for controlling active set updating in a soft handover process provided in this embodiment of the present invention, an active set is no longer updated by using an initial threshold initially configured by a network side, and the active set is updated according to a modified threshold obtained when the initial threshold is modified, where the modified threshold is less than the initial threshold, so that more cells can enter the active set. Therefore, the embodiments of the present invention can adjust an initial threshold and better adapt to actual radio frequency performance and an actual network status of a mobile terminal, and the mobile terminal can simultaneously use more cell signals, thereby improving communication quality.

The modified threshold may be acquired in different acquiring manners according to an actual case, and in the present invention, implementation of the method for controlling active set updating in a soft handover process in the foregoing embodiment is described in detail below with reference to an actual application.

First Implementation Manner:

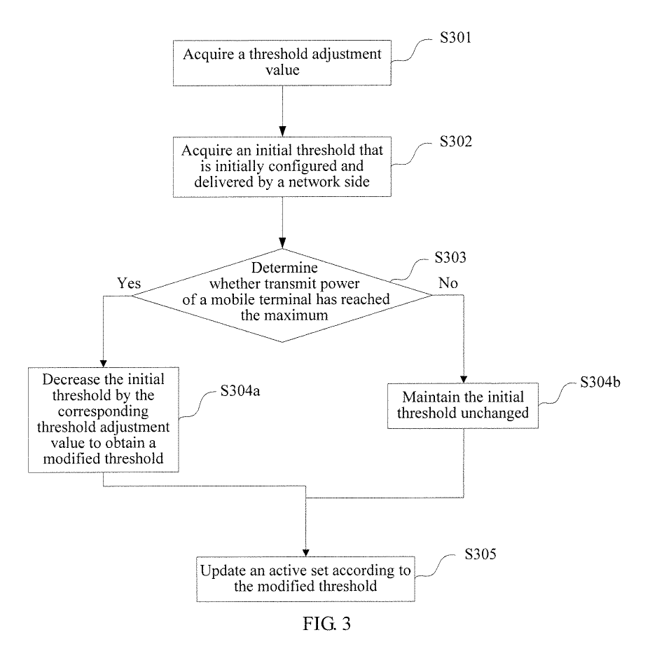

In this embodiment of the present invention, the mobile terminal may adjust the initial threshold delivered by the network side, to obtain the modified threshold. In this embodiment of the present invention, the mobile terminal modifies the threshold adjustment value initially configured by the network side, to obtain the modified threshold. A specific implementation manner of updating an active set based on the threshold adjustment value is shown in FIG. 2, and the method includes:

S201. Acquire a preconfigured threshold adjustment value.

S202. Acquire an initial threshold delivered by a network side.

S203. Decrease the initial threshold acquired in S202 by the threshold adjustment value acquired in S201, to obtain a modified threshold.

S204. Update an active set according to the modified threshold.

In this embodiment of the present invention, the mobile terminal decreases the initial threshold initially configured and delivered by the network side by the corresponding threshold adjustment value, to obtain the modified threshold, and updates the active set according to the modified threshold, so that more cells enter the active set. For example, a cell that is peripheral to a cell to which the mobile terminal belongs and that has signal strength less than the initial threshold but greater than the modified threshold can enter the active set, so that the mobile terminal can simultaneously use signals transmitted by network devices to which more cells belong, thereby improving communication quality.

In this embodiment of the present invention, the initial threshold delivered by the network side may be modified according to a radio frequency performance indicator of the mobile terminal, to obtain the modified threshold. The radio frequency performance indicator of the mobile terminal is a performance indicator that reflects strength of a signal received and sent by the mobile terminal, and the radio frequency performance indicator of the mobile terminal is generally a factory default value. In this embodiment of the present invention, the initial threshold delivered by the network side may be modified based on a radio frequency performance indicator of the mobile terminal according to an actual case, to lower a condition for a cell to enter the active set, and obtain the modified threshold.

In the method for controlling active set updating provided in this embodiment of the present invention, the initial threshold delivered by the network side may be constantly modified according to a radio frequency performance indicator of the mobile terminal. In this way, a condition for a cell to enter the active set can be lowered, and the mobile terminal can simultaneously use signals transmitted by network devices to which more cells belong, thereby improving communication quality.

In this embodiment of the present invention, the initial threshold delivered by the network side may further be dynamically adjusted according to a network status of the mobile terminal, to adjust a quantity of cells in the active set used by the mobile terminal in a communication process, thereby achieving an objective of optimizing a communication process.

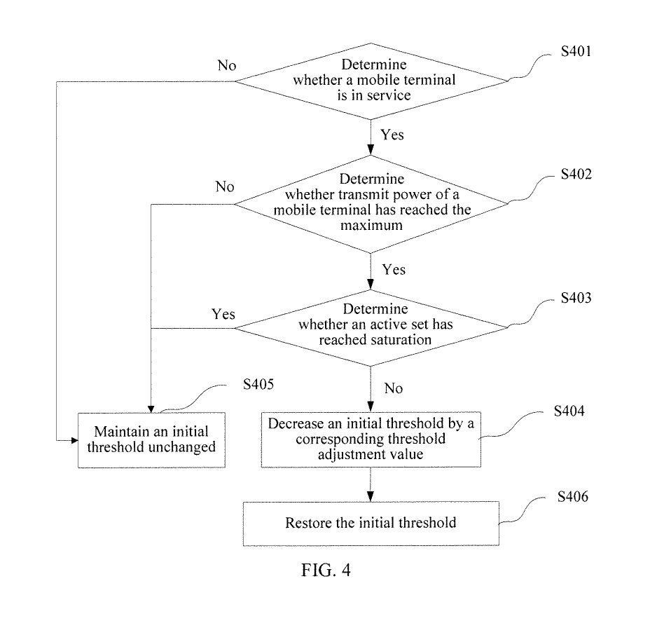

In a scenario of a relatively poor network signal, when a network device cannot normally parse signaling sent by the mobile terminal, the network device requires the mobile terminal to constantly increase transmit power of the mobile terminal. As the transmit power of the mobile terminal is higher, the network device can better parse the signaling sent by the mobile terminal. When the transmit power of the mobile terminal has reached the maximum, if the network device still cannot normally parse the signaling sent by the mobile terminal, a call drop or intermittent communication problem occurs. In this embodiment of the present invention, to avoid this phenomenon, the initial threshold may be modified according to whether the transmit power of the mobile terminal has reached the maximum. As shown in FIG. 3, a specific implementation process includes:

S301. Acquire a threshold adjustment value.

S302. Acquire an initial threshold that is initially configured and delivered by a network side.

S303. Determine whether transmit power of a mobile terminal has reached the maximum. If it is determined that the transmit power of the mobile terminal has reached the maximum, perform S304a, and otherwise, perform S304b to maintain the initial threshold unchanged.

In this embodiment of the present invention, the determined transmit power of the mobile terminal is transmit power currently used by the mobile terminal.

S304a. Decrease the initial threshold by the corresponding threshold adjustment value to obtain a modified threshold.

S304b. Maintain the initial threshold unchanged.

S305. Update an active set according to the modified threshold.

Optionally, in this embodiment of the present invention, the initial threshold may further be modified according to a status of the active set. In this embodiment of the present invention, the status of the active set may include a status of whether the active set has reached saturation. A status that the active set has reached saturation refers to that a quantity of pilots in the active set has reached a maximum value, and no more pilots can be included, that is, a quantity of cells in the active set has reached saturation. That the active set has not reached saturation refers to that the active set may further include a new pilot, that is, the quantity of the cells in the active set has not reached saturation.

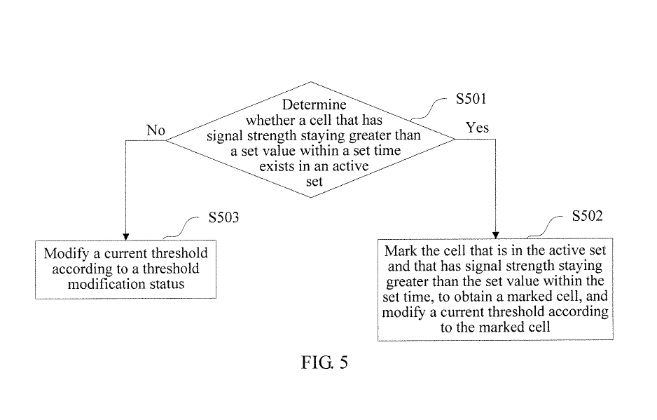

In an embodiment of the present invention, preferably, a process of modifying the initial threshold according to a status of the active set and the transmit power of the mobile terminal is implemented in the following manner, as shown in FIG. 4, which includes:

S401. Determine whether a mobile terminal is in service.

In this embodiment of the present invention, that the mobile terminal is in service refers to that the mobile terminal is performing communication. In this embodiment of the present invention, if it is determined that the mobile terminal is not in service, perform S405, so that the initial threshold initially configured by the network side is not modified, and the initial threshold is maintained unchanged; and if it is determined that the mobile terminal is in service, perform S402.

S402. Determine whether transmit power of a mobile terminal has reached the maximum.

If the transmit power of the mobile terminal has reached the maximum, perform S403, and otherwise, perform S405 to maintain the initial threshold unchanged.

S403. Determine whether an active set has reached saturation.

If the active set has not reached saturation, perform S404 to modify the initial threshold, and otherwise, perform S405 to maintain the initial threshold unchanged.

S404. Decrease an initial threshold by a corresponding threshold adjustment value.

S405. Maintain an initial threshold unchanged.

Optionally, in this embodiment of the present invention, whether the mobile terminal is in service may further be monitored in real time, and if the mobile terminal exits from a service, step S406 may further be performed.

S406. Change, back to the initial threshold, a threshold obtained by decreasing the initial threshold.

In this embodiment of the present invention, a process of modifying the initial threshold is implemented by using the method shown in FIG. 4. In a case in which the mobile terminal is in service, the transmit power of the mobile terminal has reached the maximum, and the active set has not reached saturation, the initial threshold is decreased, and otherwise, the initial threshold is maintained, as shown in the following Table 1:

TABLE 1

| Status of an active | Transmit power of a | Threshold used to |
|---|---|---|
| set | mobile terminal | update an active set |
| Has not reached | Has not reached maximum | Initial threshold |
| saturation | transmit power | |
| Has not reached | Has reached maximum | Threshold obtained by |
| saturation | transmit power | decreasing an initial |
| | | threshold |
| Has reached | Has not reached maximum | Initial threshold |
| saturation | transmit power | |
| Has reached | Has reached maximum | Initial threshold |
| saturation | transmit power | |

In this embodiment of the present invention, when the mobile terminal detects that the transmit power has reached the maximum, and the active set has not reached saturation, the initial threshold is decreased, to lower a condition for a cell to enter the active set, so that it is more easy to add, to the active set, a cell that is not in the active set, and it is more difficult to delete a cell that is already in the active set, thereby achieving an objective of increasing a quantity of cells in the active set. In this way, the mobile terminal can simultaneously use signals transmitted by network devices to which more cells belong, thereby improving communication quality.

In this embodiment of the present invention, a threshold used in a process of updating the active set may be modified according to signal strength of a cell in the active set and whether a current threshold has been modified.

Generally, if the current threshold of the active set has been modified, it indicates that a cell in the current active set can satisfy communication of the mobile terminal.

Optionally, in this embodiment of the present invention, whether the current threshold is to be modified may be selected according to whether the current threshold is a modified threshold; and if the current threshold is a modified threshold on which modification has been performed, the current threshold is no longer modified; or if the current threshold is still an initial threshold, the current threshold may be modified.

Generally, if a cell having relatively strong signal strength exists in the active set, and the transmit power of the mobile terminal has reached the maximum, but a network device still cannot parse signaling sent by a mobile terminal, it indicates that the cell that has relatively strong signal strength and that is in the active set plays a minor role in a current communication process of the mobile terminal. Therefore, in this embodiment of the present invention, to further improve communication quality, a cell that has continuously desirable signal strength and that is in the active set may be deleted, so that another cell that is not in the active set can enter the active set.

Optionally, in an embodiment of the present invention, a cell that has continuously desirable signal strength (signal strength stays greater than a set value within a set time) and that is in the active set may be marked to obtain a marked cell, where the marked cell may be stored in a form of a list. In a process of updating the active set, at least one cell recorded in marked cells may be deleted from the active set according to a set rule, so that another cell that is not in the active set can enter the active set, thereby improving communication quality.

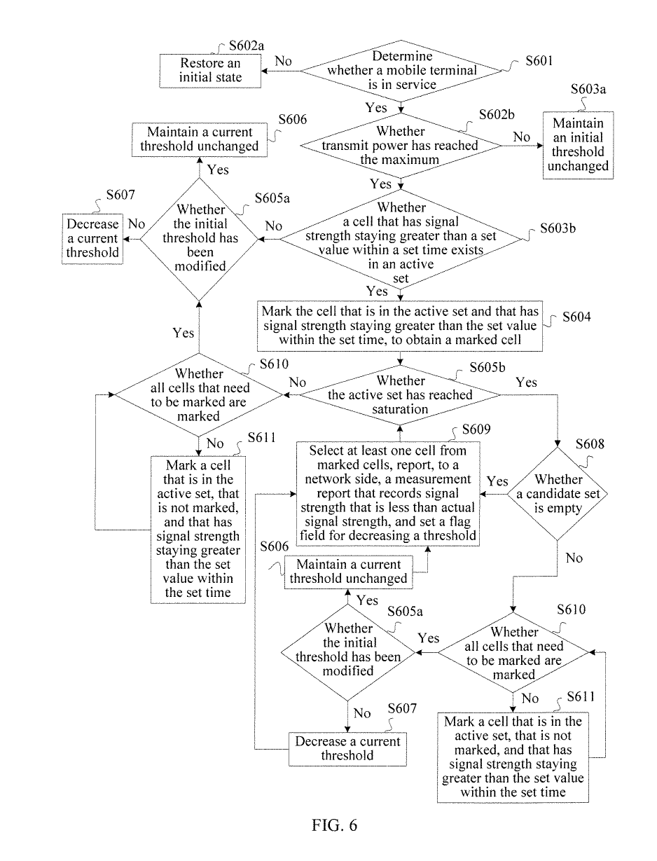

In this embodiment of the present invention, a specific implementation process of marking a cell that exists in the active set and that has a relatively desirable signal and modifying a current threshold may be shown in FIG. 5, and includes:

S501. Determine whether a cell that has signal strength staying greater than a set value within a set time exists in an active set; and if a cell that has signal strength staying greater than the set value within the set time exists, perform S502, and otherwise, perform S503.

S502. Mark the cell that is in the active set and that has signal strength staying greater than the set value within the set time, to obtain a marked cell, and modify a current threshold according to the marked cell.

S503. Modify a current threshold according to a threshold modification status.

In this embodiment of the present invention, the threshold modification status is used to indicate whether the current threshold used to update the active set has been modified, that is, the threshold modification status records whether the current threshold is an initial threshold or a modified threshold.

In this embodiment of the present invention, a corresponding modification manner may may be used by determining whether the current threshold used to update the active set has been modified (whether the current threshold is a modified threshold). If the current threshold is a modified threshold, it indicates that a threshold used to update the active set has been modified, and the current threshold maintains unchanged; and if the current threshold is an initial threshold, it indicates that a threshold used to update the active set has not been modified, and the initial threshold is decreased to modify the initial threshold.

It should be noted that, in this embodiment of the present invention, the process of marking a cell that has a continuously desirable signal and modifying a threshold shown in FIG. 5 is preferably performed in a case in which it is determined that the mobile terminal is in service, the transmit power of the mobile terminal has reached the maximum, and the active set needs to be updated.

In this embodiment of the present invention, the process of marking a cell that has a continuously desirable signal and modifying a threshold shown in FIG. 5 may be performed when cells in the active set have reached saturation, or may be performed when cells in the active set have not reached saturation.

Optionally, in this embodiment of the present invention, in a case in which cells in the active set have reached saturation, at least one cell may be selected from marked cells and deleted, so that another cell enters the active set; and if cells in the active set have not reached saturation, the current threshold may be directly modified according to the threshold modification status of the active set without needing to delete a marked cell from the active set.

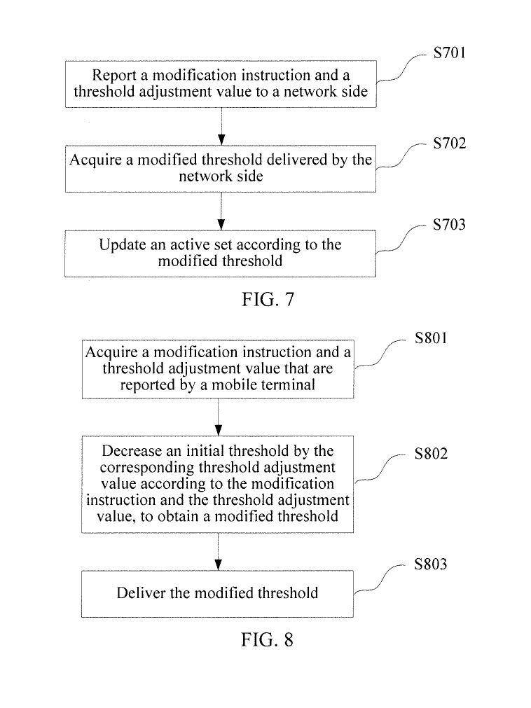

In an embodiment of the present invention, as shown in FIG. 6, a process for controlling active set updating by using a marked cell and a modification status of a current threshold includes:

S601. Determine whether a mobile terminal is in service.

In this embodiment of the present invention, that the mobile terminal is in service refers to that the mobile terminal is performing communication. For example, a call is being made with the mobile terminal.

In this embodiment of the present invention, if the mobile terminal is not in service, perform a process of restoring an initial state in S602a, and otherwise, perform S602b.

S602a. Restore an initial state.

In this embodiment of the present invention, restoring an initial state includes restoring a current threshold to an initial threshold, eliminating a flag field (S_Changed) for decreasing a threshold, so that S_Changed=0, and removing a list of marked cells (PN marking list).

S602b. Determine whether transmit power of a mobile terminal has reached the maximum; and if the transmit power of the mobile terminal has not reached the maximum, perform S603a, and otherwise, perform S603b.

S603a. Maintain an initial threshold unchanged.

S603b. Determine whether a cell that has signal strength staying greater than a set value value within a set time exists in an active set; and if a cell that has signal strength staying greater than the set value within the set time exists, perform S604 of marking the cell that is in the active set and that has signal strength staying greater than the set value within the set time, to obtain a marked cell, and otherwise, perform S605a.

S604. Mark the cell that is in the active set and that has signal strength staying greater than the set value within the set time, to obtain a marked cell.

S605a. Determine whether the initial threshold has been modified; if the initial threshold has been modified, perform S606 of maintaining a current threshold unchanged, and otherwise, perform S607 of decreasing a current threshold to modify the initial threshold.

S606. Maintain a current threshold unchanged.

S607. Decrease a current threshold to modify the initial threshold.

In this embodiment of the present invention, if the transmit power of the mobile terminal has reached the maximum, and a cell that has signal strength greater than a set value within a set time exists in the active set, the following steps may further be performed:

S605b. Determine whether a quantity of cells in the active set has reached saturation; and if the quantity of the cells in the active set has reached saturation, perform S608, and otherwise, perform S610 of determining whether all cells that exist in the active set and that have signal strength staying greater than the set value within the set time are marked.

S608. Determine whether a candidate set is empty; and if yes, perform S609, and otherwise, perform S610 of determining whether all cells that exist in the active set and that have signal strength staying greater than the set value within the set time are marked.

S609. Select at least one cell from marked cells, report, to a network side, a measurement report that records signal strength that is less than actual signal strength, and set a flag field for decreasing a threshold, that is, S_Changed=1.

In this embodiment of the present invention, an implementation manner of selecting at least one cell from marked cells may be flexibly selected. For example, in this embodiment of the present invention, to implement a simple first in first out principle of a program in a program code stack, the at least one cell may be selected from the marked cells in a chronological order of marking moments of cells. For another example, in this embodiment of the present invention, to better delete a useless cell from the active set, the at least one cell may be selected from the marked cells in descending order of signal strength of the marked cells.

In this embodiment of the present invention, signal strength of a corresponding cell that cell that is recorded in the measurement report reported to the network side is less than actual signal strength of the cell, so that the mobile terminal deletes the selected cell from the active set according to an instruction delivered by the network side, so that another cell can enter the active set.

S610. Determine whether all the cells that exist in the active set and that have signal strength staying greater than the set value within the set time are marked.

In this embodiment of the present invention, in a process of determining whether all the cells that exist in the active set and that have signal strength staying greater than the set value within the set time are marked, it may be determined whether a to-be-marked cell PNₓ set exists in a list of marked cells (PN list).

In this embodiment of the present invention, if the active set has not reached saturation, and all the cells that exist in the active set and that have signal strength staying greater than the set value within the set time are marked, return to perform steps S605a to S607. If the active set has reached saturation, and all the cells that exist in the active set and that have signal strength staying greater than the set value within the set time are marked, similarly perform steps S605a to S607, and a difference from the case in which the active set has not reached saturation lies in that, in this embodiment of the present invention, step S609 may further be performed to report the measurement report to the network side, where signal strength, recorded in the measurement report, of a cell selected from marked cells is less than actual signal strength of the cell.

In this embodiment of the present invention, if cells that are in the active set and that need to be marked are not all marked, perform S611.

S611. Mark a cell that is in the active set, that is not marked, and that has signal strength staying greater than the set value within the set time, to obtain a marked cell, and return to perform S610 of determining whether all the cells that exist in the active set and that have signal strength staying greater than the set value within the set time are marked, until all the cells that exist in the active set and that have signal strength staying greater than the set value within the set time are marked.

In this embodiment of the present invention, in the method for controlling active set updating, a cell that exists in an active set and that has signal strength greater than a set value within a set time is marked, at least one cell is selected from marked cells in a case in which the active set has reached saturation, and a measurement report that records signal strength of the selected at least one cell is reported to a network side, where the signal strength of the selected at least one cell that is recorded in the measurement report is less than actual signal strength of the at least one cell. In this way, the mobile terminal can delete a corresponding cell from the active set according to an instruction delivered by the network side, so that another cell can enter the active set, thereby improving communication quality.

In this embodiment of the present invention, the foregoing first implementation manner manner of implementing a process of acquiring a modified threshold is an implementation manner in which a mobile terminal is used to inactively perform modification, but a threshold for updating an active set is sent to the mobile terminal by a network side. Therefore, in an embodiment of the present invention, an implementation manner in which the network side directly sends the modified threshold may also be used.

Second Implementation Manner:

In this embodiment of the present invention, a mobile terminal may report, to a network side according to an actual communication case, a threshold adjustment value and a modification instruction for modifying an initial threshold, the network side modifies the initial threshold according to the received modification instruction and threshold adjustment value, to obtain a modified threshold, and delivers the modified threshold to the mobile terminal, and the mobile terminal acquires the modified threshold delivered by the network side, updates an active set by using the modified threshold, and adjusts a quantity of cells in the active set used by the mobile terminal in a communication process, thereby achieving an objective of optimizing a communication process.

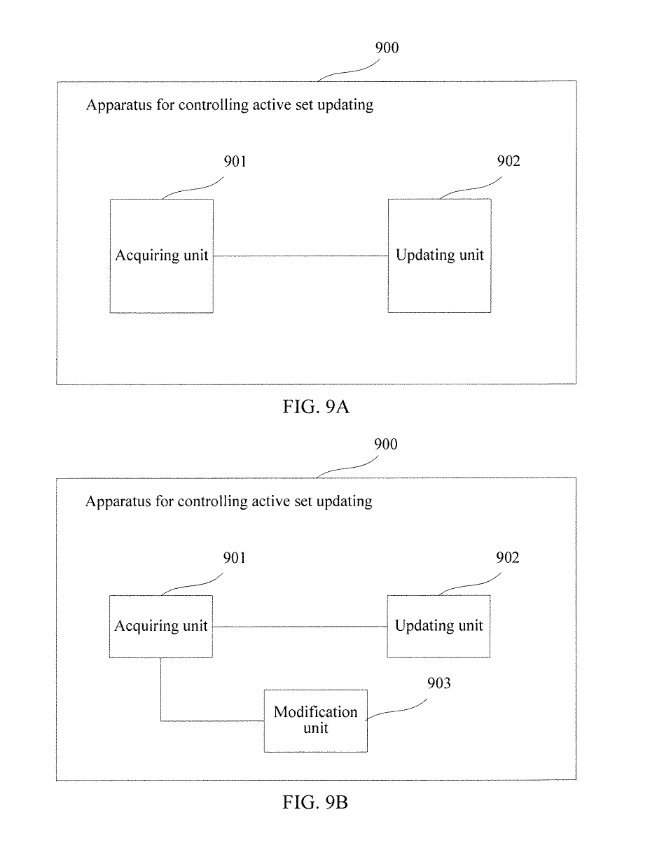

Preferably, in this embodiment of the present invention, a specific implementation process in which the mobile terminal interacts with the network side to acquire the modified threshold, and updates the active set based on the modified threshold is shown in FIG. 7, and includes:

S701. Report, to a network side, a modification instruction for modifying an initial threshold initially configured by a network side, and send a threshold adjustment value to the network side.

S702. Acquire a modified threshold delivered by the network side.

In this embodiment of the present invention, the acquired modified threshold is obtained when the network side decreases the initial threshold by the corresponding threshold adjustment value according to the modification instruction and the threshold adjustment value in S701.

S703. Update an active set according to the modified threshold.

In this embodiment of the present invention, the network side decreases the initially initially configured initial threshold by the corresponding threshold adjustment value according to the modification instruction and the threshold adjustment value that are reported by the mobile terminal, to obtain the modified threshold that is less than the initial threshold, and delivers the modified threshold to the mobile terminal, and the mobile terminal updates the active set according to the acquired modified threshold. That is, in the present invention, the mobile terminal may interact with the network side to acquire the modified threshold. Compared with inactive modification performed on a threshold by the mobile terminal, the present invention can more flexibly adapt to a current network status. For example, cell coverage controlled by a network device on the network side cannot satisfy a current communication requirement, and the mobile terminal may directly report the modification instruction, so that the mobile terminal accesses a better cell, thereby improving communication quality.

It should be noted that, in this embodiment of the present invention, before the mobile terminal reports the modification instruction and the threshold adjustment value to the network side, a current network status of the mobile terminal may also be determined, and when a set condition is met, the modification instruction and the threshold adjustment value are reported to the network side. For example, it may be determined whether transmit power of a mobile terminal has reached the maximum, and when it is determined that the transmit power of the mobile terminal has reached the maximum, the modification instruction and the threshold adjustment value are reported to the network side. For example, after it is determined that the transmit power of the mobile terminal has reached the maximum, it may further be determined whether a quantity of cells in the active set has reached saturation, and after it is determined that the quantity of the cells in the active set has not reached saturation, the modification instruction and the threshold adjustment value are reported to the network side. Certainly, when it is determined that the transmit power of the mobile terminal has reached the maximum, and the quantity of the cells in the active set has reached saturation, at least one cell may further be selected from marked cells, and a measurement report that records signal strength of the at least one cell is reported to the network side, where the signal strength of the at least one cell that is recorded in the measurement report is less than actual signal strength of the at least one cell.

In the second implementation manner in this embodiment of the present invention, a condition that is satisfied so that the modification instruction and the threshold adjustment value are reported to the network side is the same as a condition that is satisfied so that the mobile terminal modifies the initial threshold adjustment value in the first implementation manner, details are not described herein again, and reference may be made to a related description of the first implementation manner.

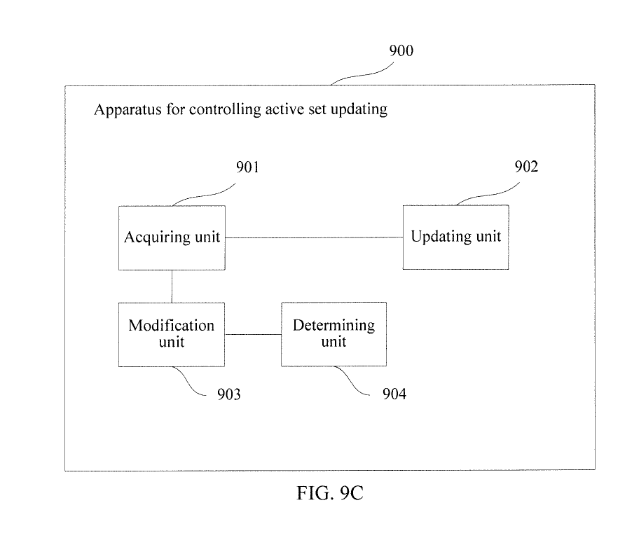

Based on the foregoing second implementation manner, this embodiment of the present invention further provides a method for controlling active set updating in a soft handover process. The method may be executed by a network device on a network side or each component in a network device, and the network device on the network side may be, for example, a base station. As shown in FIG. 8, the method includes:

S801. Acquire a modification instruction and a threshold adjustment value that are reported by a mobile terminal.

In this embodiment of the present invention, the modification instruction reported by the mobile terminal is used to instruct to modify the initial threshold for updating the active set. The threshold adjustment value is used to modify and adjust the initial threshold adjustment value.

S802. Decrease, by the corresponding threshold adjustment value according to the modification instruction and the threshold adjustment value that are acquired in S801, an initial threshold that is initially configured and that is used to update an active set, to obtain a modified threshold.

In this embodiment of the present invention, the modified threshold is less than the initial threshold, so that more cells in the active set can be used by the mobile terminal.

S803. Deliver the modified threshold obtained in S802.

In this embodiment of the present invention, the modified threshold obtained by means of modification may be delivered to the mobile terminal, so that the mobile terminal can update the active set according to the modified threshold, and more cells in the active set can be used by the mobile terminal, thereby improving communication quality.

In the method for controlling active set updating in a soft handover process provided in this embodiment of the present invention, a network side modifies an initially configured initial threshold according to a modification instruction reported by a mobile terminal, to obtain a modified threshold, and delivers the modified threshold to the mobile terminal, and the mobile terminal directly updates an active set according to the acquired modified threshold. That is, in the present invention, the mobile terminal may interact with the network side to acquire the modified threshold. Compared with inactive modification performed on a threshold by the mobile terminal, the present invention can more flexibly adapt to a current network status. For example, cell coverage controlled by a network device on the network side cannot satisfy a current communication requirement, and the mobile terminal may directly report the modification instruction, so that the mobile terminal accesses a better cell, thereby improving communication quality.

By using the method for controlling active set updating provided in this embodiment of the present invention, communication quality can be relatively desirably improved, an optimization test is performed on a mobile terminal whose TRP (Total Radiated Power, total radiated power) is around 18 dB, and whose TIS (Total Isotropic Sensitivity, total isotropic sensitivity) is around −103, and test results are shown in Table 2, Table 3, and Table 4:

TABLE 2

| | | | Quantity of | Quantity of | Quantity of times | |
|---|---|---|---|---|---|---|
| | | | times of | times of | of intermittent | Intermittence |
| Property | TRP | TIS | tests | silence | silence | rate |
| Original | 17.97 | −103 | 125 | 27 | 47 | 37.6% |
| Original | 18.11 | −104.5 | 125 | 19 | 38 | 30.4% |
| Optimized | 17.57 | −104.4 | 125 | 15 | 27 | 21.6% |
| Optimized | 17.77 | −102.1 | 125 | 10 | 14 | 11.2% |
| Other | 19.47 | −103.4 | 75 | 13 | 26 | 34.7% |

TABLE 3

| | | | | | Quantity | |
|---|---|---|---|---|---|---|
| | | | | Quantity | of times | |
| | | | Quantity | of | of inter- | Inter- |
| | | | of times | times of | mittent | mittence |
| Property | TRP | TIS | of tests | silence | silence | rate |
| Optimized | 17.97 | −103 | 50 | 3 | 7 | 14% |
| Optimized | 18.11 | −104.5 | 50 | 4 | 9 | 18% |
| Original | 17.57 | −104.4 | 50 | 2 | 14 | 28% |
| Original | 17.77 | −102.1 | 50 | 8 | 16 | 32% |

TABLE 4

| | | Intermittence improvement rate = (intermittence rate A- |
|---|---|---|
| TRP | TIS | intermittence rate B)/intermittence rate A |
| 17.97 | −103 | 62.7% |
| 18.11 | −104.4 | 40.8% |
| 17.57 | −104.4 | 23% |
| 17.77 | −102.1 | 65% |

As can be known from Table 2, Table 3, and Table 4, a communication performance performance improvement rate is above 20%, where as antenna performance is poorer, improvement is more obvious, and maximally may be above 60% in the test data. Regardless of whether OTA performance is better than or slightly worse than a mobile phone of another model, a communication intermittence status of a machine that improves a small packet is better than a machine of another model by over 10%.

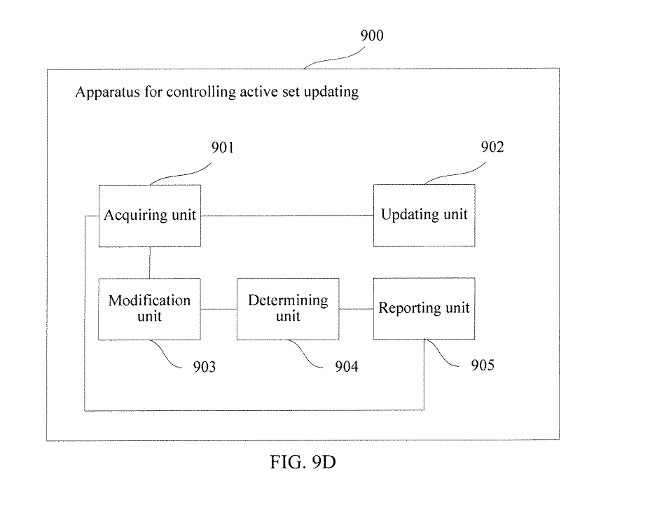

Based on the method for controlling active set updating provided in FIG. 1 to FIG. 7 in the embodiments of the present invention, an embodiment of the present invention further provides an apparatus 900 for controlling active set updating. As shown in FIG. 9A, the apparatus includes an acquiring unit 901 and an updating unit 902.

The acquiring unit 901 is configured to acquire a preconfigured threshold adjustment value, and acquire a modified threshold obtained when an initial threshold initially configured by a network side is modified based on the threshold adjustment value, where the modified threshold is less than the initial threshold.

The updating unit 902 is configured to update an active set according to the modified threshold acquired by the acquiring unit 901.

With reference to the apparatus for controlling active set updating provided above, in a first implementation manner, the acquiring unit 901 is configured to acquire the initial threshold that is initially configured and delivered by the network side;

as shown in FIG. 9B, the apparatus further includes a modification unit 903, where

the modification unit 903 is configured to decrease the initial threshold acquired by the acquiring unit 901 by the corresponding threshold adjustment value to obtain the modified threshold; and

the acquiring unit is specifically configured to acquire, in the following manner, the modified threshold obtained when the initial threshold initially configured by the network side is modified based on the threshold adjustment value:

acquiring the modified threshold obtained when the modification unit 903 decreases the initial threshold by the threshold adjustment value.

As shown in FIG. 9C, in a second implementation manner, the apparatus further includes a determining unit 904, where

the determining unit 904 is configured to: before the modification unit 903 decreases the initial threshold by the threshold adjustment value, determine whether transmit power of a mobile terminal has reached the maximum, and determine that the transmit power of the mobile terminal has reached the maximum.

As shown in FIG. 9D, in a third implementation manner, the apparatus further includes a reporting unit 905, where

the reporting unit 905 is configured to report, to the network side, a modification instruction for modifying the initial threshold initially configured by the network side, and send the threshold adjustment value to the network side; and

the acquiring unit 901 is specifically configured to acquire, in the following manner, the modified threshold obtained when the initial threshold initially configured by the network side is modified based on the threshold adjustment value:

acquiring the modified threshold delivered by the network side, where the modified threshold is obtained when the network side decreases the initial threshold by the threshold adjustment value according to the modification instruction and the threshold adjustment value.

In a fourth implementation manner, the determining unit 904 is further configured to:

after determining that the transmit power of the mobile terminal has reached the maximum, determine whether a quantity of cells in the active set has reached saturation, and determine that the quantity of the cells in the active set has not reached saturation.

In a fifth implementation manner, the determining unit 904 is further configured to: after determining that the transmit power of the mobile terminal has reached the maximum, determine whether a cell that has signal strength staying greater than a set value within a set time exists in the active set; and

as shown in FIG. 9E, the apparatus further includes a marking unit 906, where

the marking unit 906 is configured to: when a determining result of the determining unit 904 is that a cell that has signal strength staying greater than the set value within the set time exists in the active set, mark the cell that is in the active set and that has signal strength staying greater than the set value within the set time, to obtain a marked cell; or

the determining unit 904 is further configured to: when a determining result is that a cell that has signal strength staying greater than the set value within the set time does not exist in the active set, determine whether a current threshold has been modified, and determine that the current threshold has not been modified.

In a sixth implementation manner, the determining unit 904 is further configured to: after the marking unit 906 marks the cell that is in the active set and that has signal strength staying greater than the set value within the set time, to obtain a marked cell, determine whether a quantity of cells in the active set has reached saturation; and

the reporting unit 905 is configured to: when a determining result of the determining unit 904 is that the quantity of the cells in the active set has reached saturation, select at least one cell from marked cells, and report, to the network side, a measurement report that records signal strength of the at least one cell, where the signal strength of the at least one cell that is recorded in the measurement report is less than actual signal strength of the at least one cell; or

the determining unit 904 is further configured to: when a determining result is that the quantity of the cells in the active set has not reached saturation, determine whether a current threshold has been modified, and determine that the current threshold has not been modified.

In a seventh implementation manner, the determining unit 904 is further configured to:

before the reporting unit 906 reports the measurement report, determine whether a quantity of cells in a candidate set has reached saturation, and determine that the quantity of the cells in the candidate set has not reached saturation; or

before the reporting unit 906 reports the measurement report to the network side, determine whether a current threshold has been modified, and determine that the current threshold has been modified.

In an eighth implementation manner, the reporting unit 906 is specifically configured to select at least one cell from the marked cells in the following manner:

selecting, in a chronological order of marking moments of the marked cells, at least one cell from the marked cells; or

selecting, in descending order of signal strength of the marked cells, at least one cell from the marked cells.

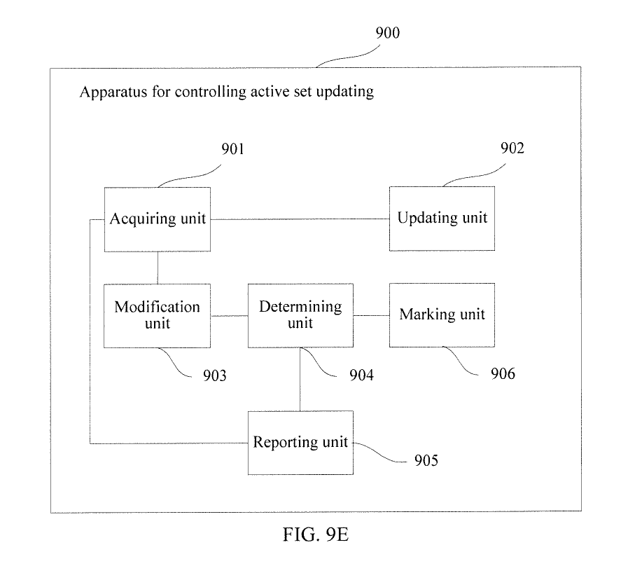

Based on the method for controlling active set updating in a soft handover process provided in FIG. 1 to FIG. 7 in the embodiments of the present invention, an embodiment of the present invention further provides an apparatus 1000 for controlling active set updating in a soft handover process. As shown in FIG. 10, the control apparatus 1000 includes a communications interface 1001, a processor 1002, a memory 1003, and a bus 1004, where the communications interface 1001, the processor 1002, and the memory 1003 are all connected to the bus 1004.

There may be one or more memories 1003, which may be a read-only memory (read-only memory, ROM) or another type of static storage device that can store static information and a static instruction, or a random access memory (random access memory, RAM) or another type of dynamic storage device that can store information and an instruction, or may be an electrically erasable programmable read-only memory (Electrically Erasable Programmable Read-Only Memory, EEPROM), a compact disc read-only memory (Compact Disc Read-Only Memory, CD-ROM) or another compact disc storage medium, optical disc storage medium (including a compact disc, a laser disc, an optical disc, a digital versatile disc, a blu-ray disc, and the like) and magnetic disk storage medium, another magnetic storage device, or any other medium that can be configured to carry or store desired program code in the form of an instruction or a data structure and that is accessible to a computer, but is not limited thereto.

In this embodiment of the present invention, the memory 1003 is configured to store program code executed by the processor 1002.

The processor 1002 may be a general-purpose central processing unit (CPU), a microprocessor, an application-specific integrated circuit (application-specific integrated circuit, ASIC), or one or more integrated circuits configured to control a program to be executed in the solution of the present invention.

In this embodiment of the present invention, the processor 1002 is configured to invoke a program stored in the memory 1003, to perform the following functions:

by using the communications interface 1001, acquiring a preconfigured threshold adjustment value, acquiring a modified threshold obtained when an initial threshold initially configured by a network side is modified based on the threshold adjustment value, and updating an active set according to the modified threshold, where the modified threshold is less than the initial threshold.

In this embodiment of the present invention, the bus 1004 may include a channel, to transfer information between the foregoing components.

In this embodiment of the present invention, any apparatus such as a transceiver may be used as the communications interface 1001, which is configured to communicate with another device or a communications network such as Ethernet, a radio access network (RAN), or a wireless local area network (Wireless Local Area Networks, WLAN).

In a first implementation manner, the processor 1002 is specifically configured to acquire, in the following manner by using the communications interface 1001, the modified threshold obtained when the initial threshold initially configured by the network side is modified based on the threshold adjustment value:

acquiring, by using the communications interface 1001, the initial threshold that is initially configured and delivered by the network side; and

decreasing the initial threshold by the threshold adjustment value to obtain the modified threshold.

In a second implementation manner, the processor 1002 is further configured to:

before decreasing the initial threshold by the threshold adjustment value, determine whether transmit power of a mobile terminal has reached the maximum, and determine that the transmit power of the mobile terminal has reached the maximum.

In a third implementation manner, the processor 1002 is specifically configured to acquire, in the following manner, the modified threshold obtained when the initial threshold initially configured by the network side is modified based on the threshold adjustment value:

reporting, to the network side by using the communications interface 1001, a modification instruction for modifying the initial threshold initially configured by the network side, and sending the threshold adjustment value to the network side; and acquiring, by using the communications interface, the modified threshold delivered by the network side, where the modified threshold is obtained when the network side decreases the initial threshold by the threshold adjustment value according to the modification instruction and the threshold adjustment value.

In a fourth implementation manner, the processor 1002 is further configured to:

before reporting, to the network side by using the communications interface 1001, the modification instruction for modifying the initial threshold initially configured by the network side, determine whether transmit power of a mobile terminal has reached the maximum, and determine that the transmit power of the mobile terminal has reached the maximum.

In a fifth implementation manner, the processor 1002 is further configured to:

after determining that the transmit power of the mobile terminal has reached the maximum, determine whether a quantity of cells in the active set has reached saturation, and determine that the quantity of the cells in the active set has not reached saturation.

In a sixth implementation manner, the processor 1002 is further configured to:

after determining that the transmit power of the mobile terminal has reached the maximum, determine whether a cell that has signal strength staying greater than a set value within a set time exists in the active set; and

if a cell that has signal strength staying greater than the set value within the set time exists, mark the cell that is in the active set and that has signal strength staying greater than the set value within the set time, to obtain a marked cell; or

if a cell that has signal strength staying greater than the set value within the set time does not exist, determine whether a current threshold has been modified, and determine that the current threshold has not been modified.

In a seventh implementation manner, the processor 1002 is further configured to:

after marking the cell that is in the active set and that has signal strength staying greater than the set value within the set time, to obtain a marked cell, determine whether a quantity of cells in the active set has reached saturation; and

if the quantity of the cells in the active set has reached saturation, select at least one cell from marked cells, and report, to the network side, a measurement report that records signal strength of the at least one cell, where the signal strength of the at least one cell that is recorded in the measurement report is less than actual signal strength of the at least one cell; or

if the quantity of the cells in the active set has not reached saturation, determine whether a current threshold has been modified, and determine that the current threshold has not been modified.

In an eighth implementation manner, the processor 1002 is further configured to:

before reporting the measurement report to the network side, determine whether a quantity of cells in a candidate set has reached saturation, and determine that the quantity of the cells in the candidate set has not reached saturation; or

before reporting the measurement report to the network side, determine whether a current threshold has been modified, and determine that the current threshold has been modified.

In a ninth implementation manner, the processor 1002 is specifically configured to select at least one cell from the marked cells in the following manner:

selecting, in a chronological order of marking moments of the marked cells, at least one cell from the marked cells; or

selecting, in descending order of signal strength of the marked cells, at least one cell from the marked cells.

The apparatus for controlling active set updating in a soft handover process provided in this embodiment of the present invention may be configured to execute the method for controlling active set updating in a soft handover process involved in FIG. 1 to FIG. 7; therefore, in the embodiments of the present invention, for details of the apparatus for controlling active set updating involved in FIG. 9A to FIG. 9E and FIG. 10, reference may be made to a related description in the method embodiments, and in this embodiment of the present invention, details are not described herein again.

It should be noted that, in this embodiment of the present invention, the apparatus for controlling active set updating involved in FIG. 9A to FIG. 9E and FIG. 10 may be, for example, a mobile terminal, or each component in a mobile terminal, which is not limited in this embodiment of the present invention.

In the apparatus for controlling active set updating provided in this embodiment of the present invention, an active set is no longer updated by using an initial threshold initially configured by a network side, and the active set is updated according to a modified threshold obtained when the initial threshold is modified, where the modified threshold is less than the initial threshold, so that more cells can enter the active set. Therefore, the embodiments of the present invention can adjust an initial threshold and better adapt to actual radio frequency performance and an actual network status of a mobile terminal, and the mobile terminal can simultaneously use more cell signals, thereby improving communication quality.

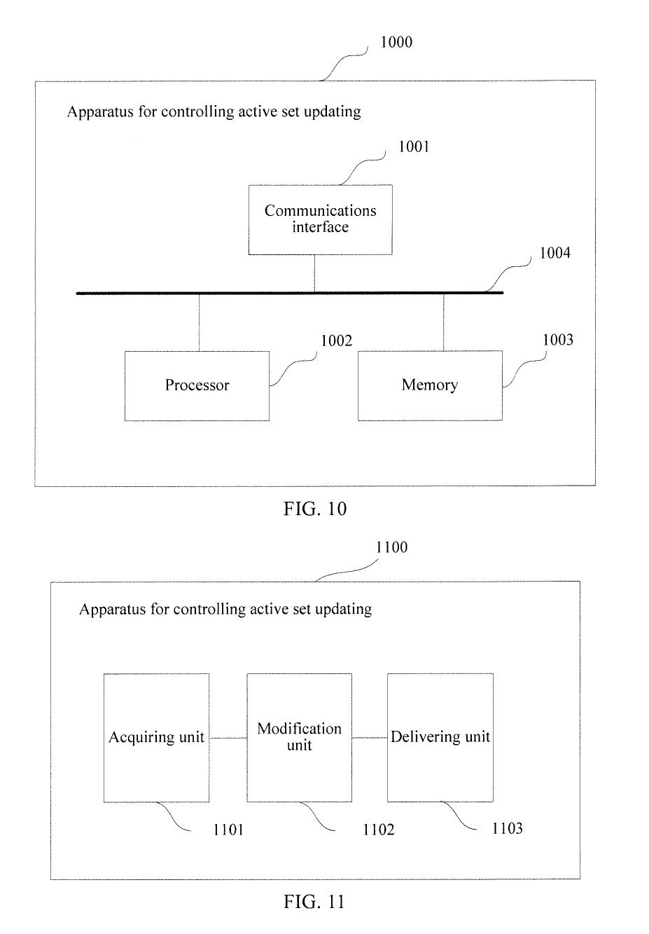

Based on the method for controlling active set updating provided in FIG. 8 in the embodiments of the present invention, an embodiment of the present invention further provides an apparatus 1100 for controlling active set updating. As shown in FIG. 11, the apparatus 1100 includes an acquiring unit 1101, a modification unit 1102, and a delivering unit 1103.

The acquiring unit 1101 is configured to acquire a modification instruction reported by a mobile terminal, where the modification instruction is used to instruct to modify an initial threshold.

The modification unit 1102 is configured to modify, according to the modification instruction acquired by the acquiring unit 1101, the initial threshold that is initially configured and that is used to update an active set, to obtain a modified threshold, where the modified threshold is less than the initial threshold.

The delivering unit 1103 is configured to deliver the modified threshold obtained by the modification unit 1102 by modifying the initial threshold.

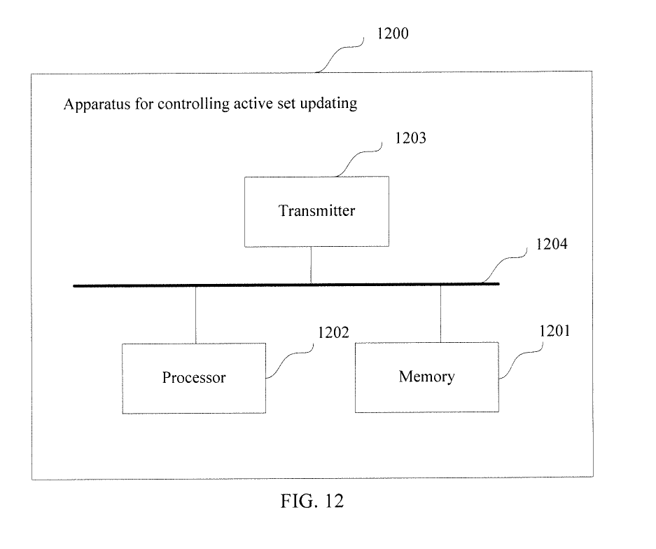

Based on the method for controlling active set updating provided in FIG. 8 in the embodiments of the present invention, an embodiment of the present invention further provides an apparatus 1200 for controlling active set updating. As shown in FIG. 12, the control apparatus 1200 includes a memory 1201, a processor 1202, a transmitter 1203, and a bus 1204, where the memory 1201, the processor 1202, and the transmitter 1203 are all connected to the bus 1204.

There may be one or more memories 1201, which may be a read-only memory (read-only memory, ROM) or another type of static storage device that can store static information and a static instruction, or a random access memory (random access memory, RAM) or another type of dynamic storage device that can store information and an instruction, or may be an electrically erasable programmable read-only memory (Electrically Erasable Programmable Read-Only Memory, EEPROM), a compact disc read-only memory (Compact Disc Read-Only Memory, CD-ROM) or another compact disc storage medium, optical disc storage medium (including a compact disc, a laser disc, an optical disc, a digital versatile disc, a blu-ray disc, and the like) and magnetic disk storage medium, another magnetic storage device, or any other medium that can be configured to carry or store desired program code in the form of an instruction or a data structure and that is accessible to a computer, but is not limited thereto.

In this embodiment of the present invention, the memory 1201 is configured to store program code executed by the processor 1202.

The processor 1202 may be a general-purpose central processing unit (CPU), a microprocessor, an application-specific integrated circuit (application-specific integrated circuit, ASIC), or one or more integrated circuits configured to control a program to be executed in the solution of the present invention.

In this embodiment of the present invention, the processor 1202 is configured to invoke invoke a program stored in the memory 1201, to perform the following functions:

acquiring a modification instruction and a threshold adjustment value that are reported by a mobile terminal, decreasing, by the threshold adjustment value according to the modification instruction and the threshold adjustment value, an initial threshold that is initially configured and that is used to update an active set, to obtain a modified threshold, where the modified threshold is less than the initial threshold, and controlling the transmitter 1203 to deliver the modified threshold, where the modified threshold is less than the initial threshold.

The transmitter 1203 is configured to communicate with another device or a communications network such as Ethernet, a radio access network (RAN), or a wireless local area network (Wireless Local Area Networks, WLAN), to deliver the modified threshold.

The apparatus for controlling active set updating in a soft handover process provided in FIG. 11 and FIG. 12 in the embodiments of the present invention may be configured to execute the method for controlling active set updating in a soft handover process involved in FIG. 8; therefore, in the embodiments of the present invention, for details of the apparatus for controlling active set updating in a soft handover process involved in FIG. 11 and FIG. 12, reference may be made to a related description in the method embodiments, and in this embodiment of the present invention, details are not described herein again.

It should be noted that, in this embodiment of the present invention, the apparatus for controlling active set updating in a soft handover process involved in FIG. 11 and FIG. 12 may be a network device (for example, a base station), or each component in a network device (for example, a base station), which is not limited in this embodiment of the present invention.

In the apparatus for controlling active set updating in a soft handover process provided in this embodiment of the present invention, an active set is no longer updated by using an initial threshold initially configured by a network side, and the active set is updated according to a modified threshold obtained when the initial threshold is modified, where the modified threshold is less than the initial threshold, so that more cells can enter the active set. Therefore, the embodiments of the present invention can adjust an initial threshold and better adapt to actual radio frequency performance and an actual network status of a mobile terminal, and the mobile terminal can simultaneously use more cell signals, thereby improving communication quality.

Persons skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, persons skilled in the art can make various modifications and variations to variations to the embodiments of the present invention without departing from the spirit and scope of the embodiments of the present invention. The present invention is intended to cover these modifications and variations provided that they fall within the scope of protection defined by the following claims and their equivalent technologies.

1-33. (canceled)

34. A method for controlling active set updating in a soft handover process, comprising:
acquiring, by a mobile terminal, a preconfigured threshold adjustment value;
acquiring, by the mobile terminal, a modified threshold based on the threshold adjustment value, wherein the modified threshold is equal to an initial threshold minus the threshold adjustment value, and the initial threshold is configured by a network side, wherein the modified threshold is less than the initial threshold; and
updating, by the mobile terminal, an active set according to the modified threshold.

35. The method according to claim 34, wherein the step of acquiring the modified threshold comprises:
acquiring the initial threshold that is initially configured and delivered by the network side; and
decreasing the initial threshold by the threshold adjustment value to obtain the modified threshold.

36. The method according to claim 35, wherein before the decreasing the initial threshold, the method further comprises:
determining, by the mobile terminal, that the transmit power of the mobile terminal has reached the maximum.

37. The method according to claim 34, wherein the step of acquiring the modified threshold comprises:
sending, by the mobile terminal, a modification instruction and the threshold adjustment value to the network side, wherein the modification instruction is used to instruct the network side to modify the initial threshold; and
receiving, by the mobile terminal, the modified threshold sent by the network side, wherein the modified threshold is obtained when the network side decreases the initial threshold by the threshold adjustment value according to the modification instruction and the threshold adjustment value.

38. The method according to claim 37, wherein before the sending the modification instruction and the threshold adjustment value, the method further comprises:
determining, by the mobile terminal, that the transmit power of the mobile terminal has reached the maximum.

39. The method according to claim 36, wherein before the decreasing the initial threshold, the method further comprises:
determining, by the mobile terminal, that the quantity of the cells in the active set has not reached saturation.

40. The method according to claim 34, wherein the step of updating the active set comprises:
determining whether a quantity of cells in the active set has reached saturation; and
if the quantity of the cells in the active set has reached saturation, selecting at least one cell from marked cells included in the active set, and reporting, to the network side, a measurement report that records signal strength of the at least one cell to make the network side delete the at least one cell from the active set, wherein the signal strength of the at least one cell that is recorded in the measurement report is less than actual signal strength of the at least one cell, wherein each cell of the marked cells has signal strength staying greater than a set value within a set time.

41. The method according to claim 34, wherein the step of updating the active set comprises:
determining whether a quantity of cells in the active set has reached saturation; and
if the quantity of the cells in the active set has not reached saturation, adding a new cell into the active set, wherein the new cell has signal strength less than the initial threshold and greater than the modified threshold.

42. The method according to claim 40, wherein the selecting at least one cell from marked cells comprises:
selecting, in descending order of signal strength of the marked cells, at least one cell from the marked cells.

43. A method for controlling active set updating in a soft handover process, comprising:
acquiring, by a network device, a modification instruction and a threshold adjustment value from a mobile terminal;
decreasing, by the threshold adjustment value according to the modification instruction and the threshold adjustment value, an initial threshold that is initially configured, to obtain a modified threshold, wherein the modified threshold is less than the initial threshold, wherein the modified threshold is equal to the initial threshold minus the threshold adjustment value; and
sending, by the network device, the modified threshold to the mobile terminal.

44. A mobile terminal, comprising a communications interface, a processor, a memory, and a bus, wherein the communications interface, the processor, and the memory are all connected to the bus, wherein
the memory is configured to store program code executed by the processor; and
the processor is configured to invoke the program code stored by the memory, to perform the following functions:
by using the communications interface, acquiring a preconfigured threshold adjustment value, and acquiring a modified threshold based on the threshold adjustment value, wherein the modified threshold is equal to an initial threshold minus the threshold adjustment value, and the initial threshold is configured by a network side; and updating an active set according to the modified threshold, wherein the modified threshold is less than the initial threshold.

45. The mobile terminal according to claim 44, wherein the acquiring the modified threshold comprises:
acquiring, by using the communications interface, the initial threshold that is initially configured and delivered by the network side; and
decreasing the initial threshold by the threshold adjustment value to obtain the modified threshold.

46. The mobile terminal according to claim 45, wherein the processor is further configured to:
before decreasing the initial threshold, determine that the transmit power of the mobile terminal has reached the maximum.

47. The mobile terminal according to claim 44, wherein the acquiring the modified threshold comprises:
sending a modification instruction and the threshold adjustment value to the network side by using the communications interface, wherein the modification instruction is used to instruct the network side to modify the initial threshold; and
receiving, by using the communications interface, the modified threshold sent by the network side, wherein the modified threshold is obtained when the network side decreases the initial threshold by the threshold adjustment value according to the modification instruction and the threshold adjustment value.

48. The mobile terminal according to claim 47, wherein the processor is further configured to:
before sending the modification instruction and the threshold adjustment value, determine that the transmit power of the mobile terminal has reached the maximum.

49. The mobile terminal according to claim 46, wherein the processor is further configured to:
before the decreasing the initial threshold, determine that the quantity of the cells in the active set has not reached saturation.

50. The mobile terminal according to claim 44, wherein the updating the active set comprises:
determine whether a quantity of cells in the active set has reached saturation; and
if the quantity of the cells in the active set has reached saturation, select at least one cell from marked cells included in the active set, and report, to the network side, a measurement report that records signal strength of the at least one cell to make the network side delete the at least one cell from the active set, wherein the signal strength of the at least one cell that is recorded in the measurement report is less than actual signal strength of the at least one cell, wherein each cell of the marked cells has signal strength staying greater than a set value within a set time.

51. The mobile terminal according to claim 44, wherein the updating the active set comprises:
determine whether a quantity of cells in the active set has reached saturation; and
if the quantity of the cells in the active set has not reached saturation, add a new cell into the active set, wherein the new cell has signal strength less than the initial threshold and greater than the modified threshold.

52. The mobile terminal according to claim 50, wherein the selecting at least one cell from marked cells comprises:
selecting, in descending order of signal strength of the marked cells, at least one cell from the marked cells.
